(19) United States
(12) Patent Application Publication
(10) Pub. No.: US 2008/0039991 A1
(43) Pub. Date: Feb. 14, 2008

(54) METHODS AND SYSTEMS FOR PROVIDING ACCURATE VEHICLE POSITIONING

(76) Inventors: Reed R. May, Seminole, FL (US); Charles T. Bye, Eden Prairie, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/463,787

(22) Filed: Aug. 10, 2006

(51) Int. Cl. G01C 22/00

(52) U.S. Cl. 701/25; 701/23; 701/213

(57) ABSTRACT

A method for navigating an autonomous vehicle along a desired path is described. The method includes manually navigating the vehicle along the desired path, measuring an environment in the vicinity of the desired path, during the manual navigation, using at least one sensor affixed to the vehicle, storing the environmental measurements as a programmed path within the vehicle, and subsequently utilizing an algorithm, the stored environmental measurements, and additional environmental measurements, to navigate the vehicle along the programmed path.

### BACKGROUND OF THE INVENTION

This invention relates generally to the control of vehicle positioning, and more specifically, to methods and systems for providing accurate vehicle positioning.

There is an unfulfilled need for an economical method to provide accurate positioning control for robotic/autonomous vehicles within known stable physical environments. One such example is in applications where an autonomous vehicle must traverse long distances when absolute positioning systems are lost. Absolute positioning systems include global navigation satellite systems (GNSS) of which, differential GPS, Galileo, and GLONASS are well known examples. For example, when differential GPS has been lost, it is still desirable for the vehicle to continue operation and maintain very accurate positioning. It is believed that in such a system heading is not as important as, for example, cross-track accuracy.

One reason that differential GPS signals may be lost by a receiver is due to obstructions of the signals between the GPS transmitters and the receiver. For GPS receivers at or near ground level, trees, buildings and other like obstructions can at least contribute to the loss of such signals. In particular applications, positions of such obstructions may be known, either in terms of absolute position or relative to the vehicle path.

### BRIEF DESCRIPTION OF THE INVENTION

In one aspect, a method for navigating an autonomous vehicle along a desired path is provided. The method comprises manually navigating the vehicle along the desired path for the purpose of training the vehicle, where training the vehicle includes, measuring an environment in the vicinity of the desired path, during the manual navigation, using at least one sensor affixed to the vehicle and storing the environmental measurements as a programmed path within the vehicle. The method further includes subsequently utilizing an algorithm, the stored environmental measurements, and additional environmental measurements, to navigate the vehicle along the programmed path, the algorithm utilizing a correlation algorithm, requiring multiple environmental measurements, to maintain a position of the vehicle relative to the programmed path.

In another aspect, a vehicle is provided that comprises at least one sensor affixed to the vehicle, and a processing device. The processing device is configured to control movement and operation of the vehicle based upon a comparison of data received from said at least one sensor during a manual navigation, for the purpose of training the vehicle, of the vehicle along a desired path and stored within the processing device as a programmed path, and data received from the at least one sensor as the vehicle navigates the programmed path based on error data provided by an algorithm. The processing device comprises a correlation algorithm to control movement and operation of said vehicle.

### BRIEF DESCRIPTION OF THE DRAWINGS

FIG. 1 is an illustration of a vehicle that incorporates a laser distance measuring device utilized in maintaining a position along a programmed path.

FIG. 2 is a block diagram of a navigation system for controlling positioning of the vehicle of FIG. 1.

FIG. 3 is a graph illustrating a cross-track range profile that may be used with the system of FIG. 2.

FIG. 4 is a graph illustrating an increased uncertainty in vehicle position based on data from a laser distance measuring device with respect to parallel or flat targets.

FIG. 5 is a graph of cross-track range observations and uncertainties associated with a range profile.

FIG. 6 is a graph illustrating estimated position errors occurring over a range profile.

FIG. 7 is a graph illustrating estimated position errors with a one degree per second heading error.

### DETAILED DESCRIPTION OF THE INVENTION

In applications where an autonomous vehicle must traverse long distances, there are times and/or locations when signals that are typically received from absolute positioning systems, such as a global navigation satellite system (GNSS) are lost. Examples of GNSS include GPS, Galileo, and GLONASS. GPS is also sometimes referred to a differential GPS. Described herein are methods and systems that allow such vehicles to continue operation and maintain a very accurate cross-track position. In one embodiment, cross-track position is maintained by processing highly accurate lateral distance measurements to known fixed reference points along a programmed path that the vehicle is to travel. In some of these applications, only a modest heading accuracy is needed. An example of a modest heading accuracy is less than two degrees, which results in a less than 0.06% ranging error, and allows the use of lower-cost gyroscopes in an inertial reference system which typically is a part of an autonomous vehicle control system.

In specific embodiment described below, a laser ranging device is utilized to perform cross-track distance measurements. In the embodiment, a system that includes the laser ranging device is configured to collect a reference data set on a training pass while the vehicle is under control of a human operator, simplifying formation of the reference data set. The reference data set may also be created based using known survey points or some combination of the two methods. The reference data is augmented, in an embodiment, with validity information by using an invalid number (−1) to indicate the absence of usable ranging data for a given data bin. The main benefit of such a system is that cross-track position is provided with a high degree of precision, but some meaningful aiding with respect to along-track position can also be derived. Under some conditions the along-track observations derived from range-profile correlation can be as accurate as the direct cross-track measurements.

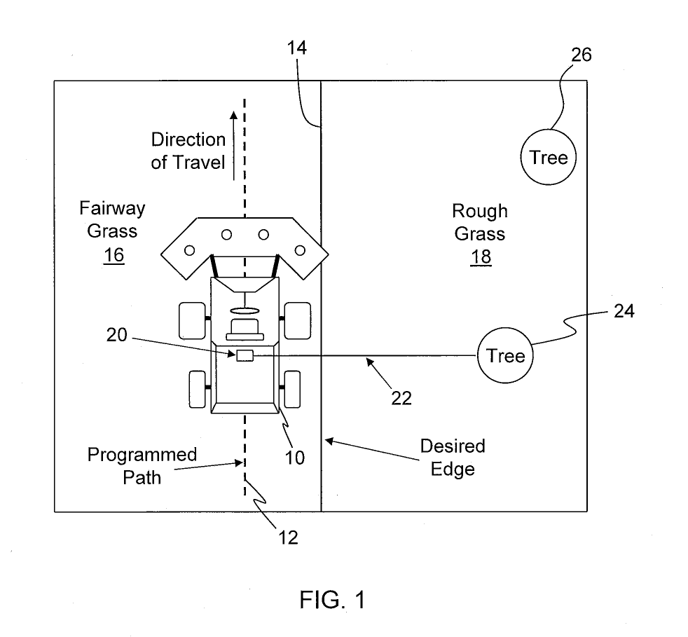

FIG. 1 is an illustration of an autonomous vehicle 10 that is configured to utilize differential GPS signals to maintain desired positioning along a route to be traveled. While the embodiments described herein sometimes refer to differential GPS, it is to be understood that the embodiments are operable with any GNSS type system, for example, Galileo and GLONASS. While not limited to such an embodiment, vehicle 10 is illustrated as being a lawnmower for a golf course and the route to be traveled is along a center cutting line or programmed path 12 which results in a demarcation (e.g., desired edge 14) between the lower cut fairway grass 16 and the higher cut rough grass 18. Vehicle 10 includes a laser distance measuring (LDM) device 20 which, in one embodiment, is configured and utilized to allow vehicle 10 to continue operation and maintain a very accurate cross-track position, for example, when data is not being received by a differential GPS receiver also mounted on vehicle 10.

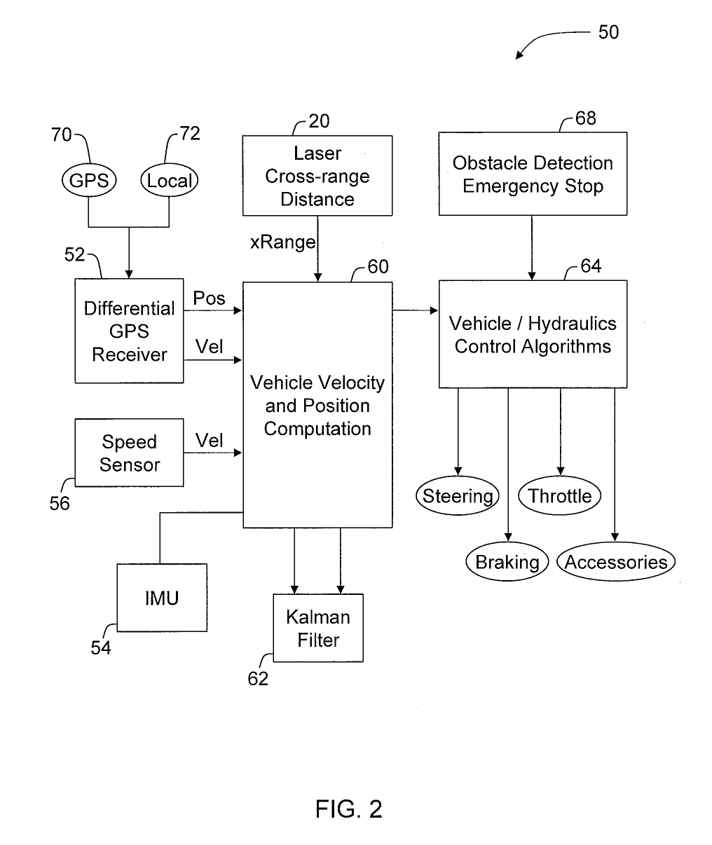

LDM device 20 operates to provide an aiding method to a basic inertial/dead-reckoning guidance system (described with respect to FIG. 2) to help maintain positional accuracy of a vehicle (e.g., a commercial mower on a golf course) when the primary differential GPS aiding is temporarily lost. Continuing with the golf course example, cross-track position accuracy is considered to be crucial for correct edge cutting. Of course, such a system is easily configurable to other applications where cross-track position accuracy is important, such as maintaining lane position on a paved road.

In the embodiment of FIG. 1, LDM device 20 is mounted on vehicle 10 such that a laser beam 22 originating from LDM device 20 is transmitting in a direction that is orthogonal to the direction of travel of vehicle 10. The laser of LDM device 20 allows precise range measurements to features, for example, trees 24 and 26 in the landscape along the programmed path 12 vehicle 10 is to travel. Any obstacles that would obstruct the GPS antenna signals, such as trees 24 and 26 should be usable as a cross-track range target for LDM device 20. As will be appreciated by those skilled in the art, in clear, open terrain LDM device 20 will not work as well, however, in such terrain it is anticipated that the GPS will be operational in such an environment.

In operation, and as shown in FIG. 1, the method includes the establishment of a profile of the landscape to a side of vehicle 10 which is essentially a range contour of the landscape relative to the desired path for vehicle 10. In addition to the illustrated trees 24 and 26, the contour can be additionally based on other fixed objects along the desired path of vehicle 10 and within the usable range of LDM device 20. Examples of such objects, in addition to trees, includes posts, signs, buildings, fences, benches, and even hillsides. Operation of vehicle 10 includes considerations regarding the levelness of the ground around programmed path 12, the mounting height of LDM device 20 on vehicle 10, and an along-track spacing of good targets. Repeatability of the measured contour of programmed path 12 and adequate spacing density of good targets, for example about 30 feet, are key elements in the successful operation of vehicle 10. In one embodiment, the establishment of the profile is provided by manually operating vehicle 10 along the desired course, at a desired speed, and recording sensor measurements during the manual operation. These recorded sensor measurements are then utilized to generate the data points for autonomous operation, based on a comparison of recorded sensor measurements and sensor measurements being taken during autonomous operation.

As alluded to above, vehicle 10 includes a navigation system 50 (shown in FIG. 2) of which LDM device 20 is a part. FIG. 2 is a block diagram of navigation system 50 which includes a differential GPS receiver 52, an inertial measurement unit 54 which provides heading reference and attitude, a Doppler radar speed sensor, or wheel speed sensor 56 and a cross-track distance measuring laser (LDM device 20) all of which are referred to collectively herein as sensors.

The sensors are configured to communicate with a processing device 60 which utilizes the data received from the various sensors to control operation of vehicle 10 (shown in FIG. 1). Differential GPS receiver 52, in one embodiment, is relied upon to provide the majority of position and velocity information to processing device 60, as well as supporting the in-motion alignment operation used to establish and maintain true heading of vehicle 10. An accuracy of a preferred embodiment of Differential GPS receiver 52, in conjunction with the GPS satellites (not shown), is about 2 centimeters per (1−σ), which is therefore an expected accuracy for the operation of vehicle 10.

IMU 54 is utilized by vehicle 10 to maintain a level reference frame and heading angle during maneuvers of vehicle 10. A drift rate of gyroscopes (not shown) within IMU 54 can be as large as 100 degrees per second though a coasting function of system 50 has a positional drift equal to or less than about two centimeters per second. Doppler radar speed sensor 56 is utilized by vehicle 10 to provide an indication of along-track speed of vehicle 10 relative to the ground surface. A typical accuracy of such a device is typically about within two percent.

As described above, LDM device 20 is utilized by vehicle 10 to aid in lateral position control of vehicle 10 during outages of differential GPS 52. A typical accuracy of LDM device 20 is about one centimeter up to target ranges of 100 yards (1−σ). In a particular embodiment, updates from LDM device 20 are received by processing device 60 at a rate equal to or greater than 100 Hz. Higher acquisition rates allow for greater detail in the range profile at the expense of larger stored data sizes.

Data received from all the sensors is processed by processing device 60, in one embodiment, utilizing a Kalman Filter model 62 that allows calibration of scale factor, alignment, bias and other errors inherent in the sensors. Processing device 60 is configured, in one embodiment, to control the motion of vehicle 10 and compute vehicle position based on data received from the sensors. The data is then used by processing device 60 to provide current speed, position, and attitude data to a vehicle position controller 64 which, as illustrated, is configured to control operation of vehicle steering, braking, throttling, and any other vehicle accessories, such as cutting blades in the golf course lawnmower example. Vehicle 10 may also be configured with an obstacle detection/vehicle stopping device 68 for safety, which provides signals to vehicle position controller 64 to override any other vehicle control signals upon detection of an obstacle or the like.

In the illustrated embodiment of FIG. 2, navigation system 50 further includes a GPS antenna 70 and a local antenna 72 receiving the signals intended for GPS receiver 52.

When navigation system 50 is turned on, or initialized, it will acquire signals from differential GPS 52 to establish an initial position and, in one embodiment, perform a short sequence of maneuvers to quickly and accurately establish an initial heading for vehicle 10. Stored headings may be utilized in appropriate applications, however, if vehicle 10 has been moved without using the navigation system, stored headings would not be useful. In one embodiment, the in-motion-alignment maneuver will initially be defined as a straight-line acceleration from zero to, for example, about eight feet per second followed by a figure-eight pattern with, for example, five foot radius circles. Refinements to alignment while differential GPS signals are being received are repeatedly being performed. These maneuvers could be configured to be done automatically as part of the machine start-up sequence without human intervention. Other basic machine service/maintenance features such as monitoring engine temperature, oil level/pressure, battery charge, hours of operation, fuel level, hydraulic pressure/fluid level, proper startup and shut-down procedures may also be incorporated into the operational program.

In various embodiments, vehicle 10 is programmed to follow a path over a course which is characterized by one or more of a timestamp, a status, a latitude/longitude, a heading, a roll, a pitch, an elevation, a forward speed, throttle setting/engine speed and cross-track range targets measured during the manual navigation (or “training” run). In the embodiment where vehicle 10 is a golf course lawnmower, a position of the cutter (e.g., a cutting height) may also be programmed. Path data programmed into vehicle 10 can be easily compressed and does not have to be evenly spaced at 100 Hz intervals. A new entry into the path data is only needed when some important parameter changes enough to be noted, for example, changes in accessory settings, appearance of usable cross-range targets, and the like.

In one embodiment, full data sets defining a programmed path are recorded and programmed into vehicle 10 at regular intervals regardless of whether there are changes that might affect the programmed path data. In one embodiment, a status word is utilized to indicate what type of data is being stored, for example, differential GPS based data, raw dead reckoning data, or corrected dead reckoning data received from LDM device 20.

In an embodiment, a programmed path is fabricated as a chronological list of data having a starting point and an ending point. In the example embodiment of the golf course lawnmower, each programmed path begins and ends with an entry/exit maneuver with the cutter bar up and stopped. A number of programmed paths may be “chained” together as appropriate using a bridging algorithm to move from the ending point of one programmed path to the starting point of the next programmed path which includes the correct heading and speed needed to start the next programmed path.

In one embodiment, preparation of a programmed path involves a skilled operator driving vehicle 10 over the desired course at the proper speed(s) while processing device 60 is in a “training mode”. While in this training mode the processing device 60, based on inputs received from “sensors” 20, 52, 54, and 56, will create programmed path data that the processing device 60 can use later to navigate vehicle 10 over this same programmed path 12 (shown in FIG. 1) with no human assistance. As the path data is collected in the training mode, it is filtered and monitored for changes.

While data from differential GPS 52 is present during the training mode, it is recorded as changes are detected in speed, heading or attitude. In one embodiment, cross-track range data received from LDM device 20 is also recorded and stored whenever a data point record from differential GPS 52 is written into a memory associated with processing device 60. In a specific embodiment, a full data point (including differential GPS data, IMU data, vehicle speed data, and cross-track range data) is recorded and stored every five seconds regardless of changes in the data.

During the training mode, the last known-good data point is recorded into memory at substantially the instant the data being received from differential GPS 52 is lost. In one embodiment, during a differential GPS outage, data points that include data from one or more of LDM device 20, IMU 54, and speed sensor 56 are recorded at a 100 Hz rate in response to any “in threshold” range value received from LDM device 20. The threshold value is used to eliminate storage of targets that are too distant from the path to be useful.

With respect to operation of LDM device 20 in the training mode, LDM device 20 is continuously supplying cross-track range profile information to a training module programmed into or coupled to processing device 60. In one embodiment, a range threshold limit is utilized to restrict collected cross-track range data to targets that are closer to the programmed path of vehicle 10. As one example, fifty meters is utilized as starting point for a range threshold limit as it is a desirable for retaining any ranging information that could be useful to operation of vehicle 10. The distance data received from LDM device 20, in one embodiment, is recorded to an accuracy of one centimeter or less.

In one embodiment, data is received from LDM device 20 by processing device 60 at a rate of about 100 Hz. In this embodiment, and as alluded to above, the last five seconds of data received from LDM device 20 is stored, for example, in a circular buffer in readiness for a possible loss of differential GPS signals. As long as differential GPS data is available no consideration is given to permanently storing data points in response to events related to output of LDM device 20. However, when GPS signals are not being received by differential GPS 52, a new data point is recorded for every “in threshold” range reported from LDM device 20 and the five second buffer is then committed to the path description. Providing this buffer creates overlap between the availability of LDM data and GPS data.

In one embodiment, utilization of the high-rate cross-track range data collected by LDM device 20, in response to loss of GPS signals, is made substantially simultaneously to the loss of the GPS signals. However, in an embodiment, a decision by processing device 60 to stop using LDM device cross-track range data for navigation of vehicle 10 requires that differential GPS 52 be operational, or in service, for more than five seconds. The high-resolution cross-track range data from LDM device 20 is utilized in a correlation algorithm to provide precision aiding to processing device 60 during normal operation. In the embodiment, the five second buffer at each end of a GPS outage during the “training run” over the programmed path is to allow for loss of GPS near the point that it was lost during the training run while in normal operation.

In one embodiment, LDM device 20 measurements that exceed the desired maximum range are set to a large fixed number, for example, twice the desired maximum range limit. If, for example, zero was utilized rather than twice the desired maximum range limit, an edge correlation effect is weakened because it brings valid data and “invalid data” closer together for near targets that may only be several meters away.

When signals associated with differential GPS 52 are reacquired after a period of lost GPS signals, the data collected by processing device 60 during the period of GPS loss has to be aligned with proper coordinates. In one embodiment, it is assumed that a single continuous GPS outage is fairly brief, for example, less than a minute, any heading/attitude drift error incurred during the outage is small, and an overall position drift is linear with time (or follows a fixed function). In the embodiment, the collected data is adjusted by making scaled two-dimensional corrections starting at an anchor point where differential GPS 52 signals were lost, thereby adjusting all positions recorded over the GPS outage such that the ending point where GPS signals were reacquired differential GPS 52 aligns with a position of differential GPS 52. In a specific embodiment, this “re-alignment process” is programmed as a background task that operates on records with a status marker of “Raw dead reckoning”. After a point is adjusted its status is changed to “corrected dead reckoning”.

Under normal conditions, for example, when differential GPS 52 is receiving signals, Kalman filter 62 is utilized to calibrate speed sensor 56, estimate slip rates as a function of attitude and speed, and maintain a correct heading angle. Guidance of vehicle 10 is accomplished by comparing a position provided by differential GPS 52, heading from IMU 54, and forward speed from speed sensor 56 with the data associated with programmed path 12. Each entry in programmed path 12 is considered a waypoint. Under these circumstances, whether differential GPS 52 is receiving signals or not, a navigation solution will include a computation of the current position, speed and heading values and processing device 60 is programmed to make appropriate guidance corrections to steer vehicle 10 to the next entry in programmed path 12.

When an outage occurs (e.g., differential GPS 52 is not receiving signals), processing device 60 is programmed to compute position, heading, and forward speed using a standard type of inertial algorithm which will use data from speed sensor 56 and cross-track range data from LDM device 20 as live aiding inputs. In a particular embodiment, during a loss of GPS signals, an integrity value is computed from covariance data to determine if the performance of vehicle is at an acceptable performance level. In the embodiment, when this integrity value exceeds, for example, 10 centimeters, processing device 60 is programmed to stop vehicle 10.

In another embodiment, zero velocity updates (ZUPTs) are utilized to extend the inertial performance range during a GPS outage. When the integrity value reaches one-half of a specified value, vehicle 10 is programmed to stop and perform ZUPTs for 30 seconds to reduce the velocity errors and then resume operation.

Data collection by LDM device 20, under normal operation (differential GPS 52 is receiving signals), is essentially the same as during the training pass. The same circular buffer technique is used to hold the last five seconds of cross-track range data. When differential GPS 52 experiences a loss of data, the cross-track range data becomes continuous with the five seconds of history data. Strong peaks in cross-track range correlation caused by edges in the data received from LDM device 20 provides very accurate along-track position updates. This data is used to correct the along track position in order to make the cross-track range data valid for lateral position corrections.

Substantially simultaneously with a loss of GPS signals at differential GPS 52, processing device 60 begins to record all cross-track range values that pass a threshold test, for example, at a 100 Hz rate. This recording of data from LDM device 20 is accomplished in the same fashion as accomplished during the training mode. This recordation of data provides the results of beginning to build a data set that can be correlated with the stored cross-track range data associated with programmed path 12. In a specific embodiment, the correlation is best done in blocks of 50 to 200 data points. For areas with no valid returns the data samples are set to twice the range limit, as is done during the training mode and the sample are considered to be received at a single rate, for example, about 100 Hz.

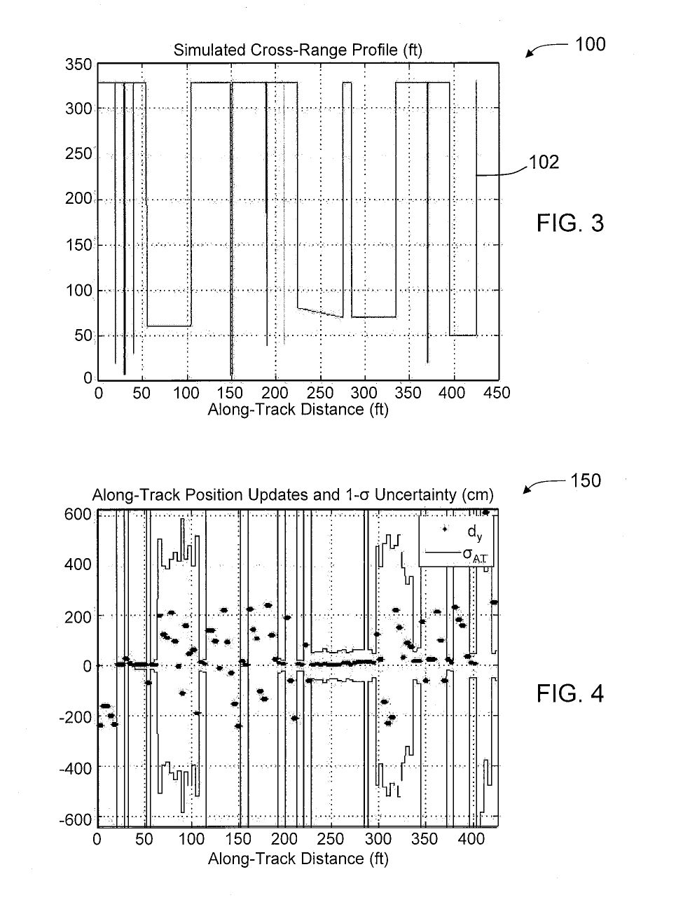

Updates to the error states of Kalman filter 62 are considered at each half-block time. The plots shown in FIGS. 3-7, described in further detail below, utilize 100 data points for along-track correlation which produces an update interval of about 0.5 seconds, with a time of validity delay of about 0.5 seconds. More specifically, at an average speed of about eight feet per second, twenty samples covers about twenty inches of programmed path 12. This resulting one inch resolution of along programmed path position allows good use of edges on smaller targets such as poles and tree trunks.

A correlation function associated with Kalman filter 62 produces a minimum and maximum mean-square-error (MSE) value over a correlation interval. The correlation data is computed as the MSE between the two data sets as a function of time skew. The along-track position aiding comes from the time alignment adjustment indicated by the minimum of the MSE values. The best fit to the stored path profile indicates the most likely position along programmed path 12. Once the best fit alignment is determined, aiding observations can be formed for both the cross-track and along-track position. In one embodiment, the cross-track observation has a 1:1 sensitivity to the cross-track range position error. The along-track position update is derived from the offset produced during the MSE fitting operation. The uncertainty of each observation is also formed for use by Kalman filter 62.

The cross-track uncertainty is provided directly form the MSE fit as the minimum correlation error at the fit point, specifically, Cross-Track Uncertainty=\sqrt{min}.

Part of the uncertainty along programmed path 12 is related to the correlation coefficient of the aligned measurement and pre-stored programmed path data. The correlation coefficient is defined as

$$correlation coefficient \text{:} ρ = \frac{covariance ( path , profile )}{{σ}_{path} {σ}_{profile}} .$$

### This equation is a standard statistical equation.

The value of the correlation coefficient expression ranges between 1 and −1 and provides a linear indication of how well the two data sets are correlated. Random noise produces a correlation coefficient of zero, identical data sets produce one and negated sets produce negative one. The total uncertainty of the along-track observations is dependent on the correlation coefficient, the correlation data set size, the heading error and data sampling resolution. An equation for this uncertainty is given as:

Along-Track Uncertainty=σ_{AT}=\sqrt{σ_{hdg}²+σ_{corr}²+σ_{quant}²}

where:

σ_{hdg}=rₘᵢₙ sin(σ_{ψ})

$${σ}_{corr} = \sqrt{{d}_{corr}^{2} ( \frac{1}{ρ} - 1 )}$$

σ_{quant}=0.5 dx and where rₘᵢₙ is the smallest range value in the correlation data set, σ_{ψ} is the heading (azimuth) uncertainty, d_{corr} is the distance spanned by the measurement data set, ρ is the correlation coefficient from the measurement data set, and dx is the sample interval (in distance units).

Cross-track range and along-track measurements are used by processing device 60 as position updates for Kalman filter 62 along with the uncertainties that were determined for LDM device 20. Additionally, an input from speed sensor 56 is also used also during periods when GPS signals are not being received by differential GPS 52. With respect to operation of LDM device 20, profiles of objects with sharp edges, such as trees, poles, signs, and the like can produce excellent along track position observations based on measurements made by LDM device 20 in addition to providing the primary cross-track range aiding. Flat features such as fences and buildings may also provide along-track aiding if the surface is not parallel to the programmed path 12.

In one embodiment, cross-track range measurement is formed as the mean of valid range data in the data set and out-of-range data is excluded. Generally, if the current measurement set only contains out-of-range data it will not be processed as an observation. Depending on the leveling error expected in the system of FIG. 1, any data received from LDM device 20 that strongly correlates with differences in roll angle (from IMU 54) could be rejected or degraded as a likely return from sloping ground. Buildings, fences and other oblique objects show very little correlation between roll angle and the range measurement.

FIG. 3 is a plot 100 that illustrates a cross-track range profile 102 used for preliminary tests of the system 50 of FIG. 2. Specifically, the out-of-range value used in the preliminary tests was 50 meters. An error budget used in these preliminary tests is summarized in Table 1.

TABLE 1
Base Error Budget for Simulations

| Speed | 8 | ft/sec |
|---|---|---|
| Position Drift | 2.0 | cm/sec |
| Odometer Error | N/A | |
| Heading Gyro Drift | 100 | deg/sec |
| Heading Noise | 0.5 | deg |
| DGPS Hdg Error | 0.25 | deg |
| DGPS Position Error | 2 | cm |
| Sample Rate (LDM) | 100 | Hz |
| LDM Error | 3 | cm |
| Cut-off Range | 50 | m |

It is possible to derive an accurate along-track position update whenever the profile as sensed by LDM device 20 experiences a strong transition over a short period of time, such as the sensing of a tree a short distance from programmed path 12. For surfaces that are perfectly parallel to programmed path 12 no real along-track aiding from LDM device 20 is possible. Plot 150 in FIG. 4 illustrates the increased uncertainty that accompanies these parallel or flat targets. Note that an “angled” target sensed at 225-275 feet does present some useful information and ranges known to be invalid were forced to an uncertainty of 99 feet which is an arbitrary value.

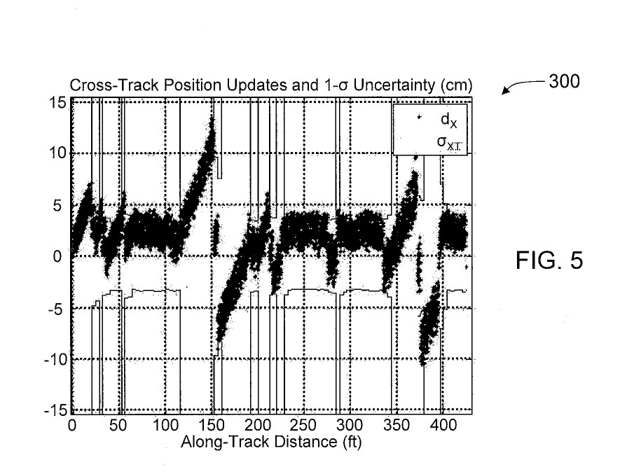

The main objective of controlling cross-track range position errors through utilization of LDM device 20 is achieved. Specifically, FIG. 5 is a plot 200 of cross-track range observations and uncertainties associated with the range profile. Plot 200 illustrates estimated position errors for the example simulation and only considers the use of cross-track range distance observations.

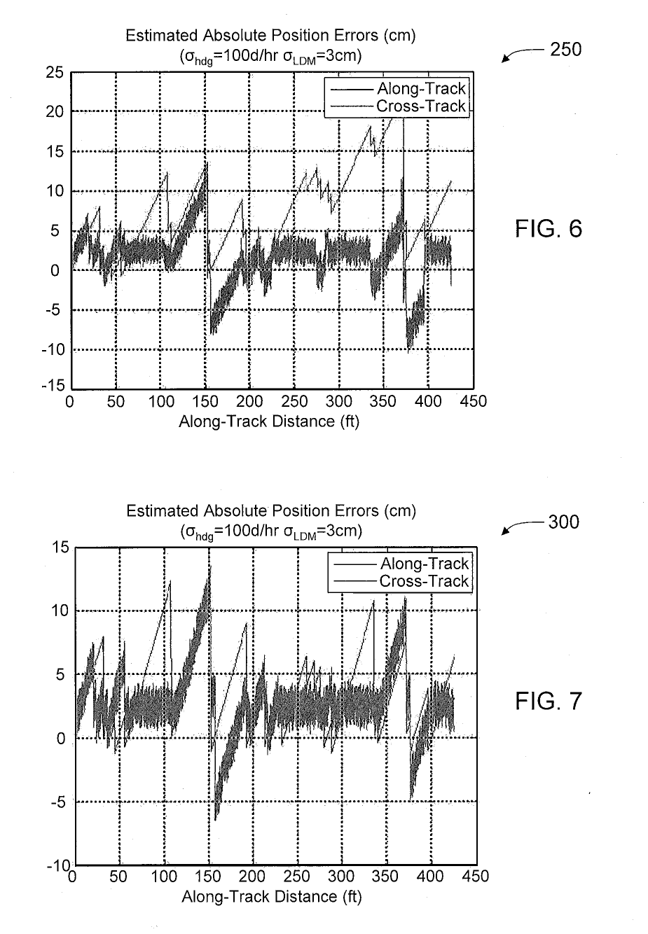

It is important to note that along track aiding has a sensitivity to both a heading error and cross-track range. FIGS. 3-5 assume a heading error drift of 50 degrees per hour associated with IMU 54. If heading error drift is reduced to one degree per hour, then the estimated error is reduced significantly. FIGS. 6 and 7 illustrate plots 250 and 300 respectively, that show an effect of reducing the heading from 50 degrees per second to one degree per second. One known gyroscope is capable of achieving a drift rate of about 200 degrees per second but this drift can be mitigated through observations made by Kalman filter 62.

The above described systems and methods assume that if there is some nearby obstruction to GPS reception there will also be some nearby feature in the landscape profile that can be used for cross-track range aiding. As such, the systems and methods described herein provide precise cross-track position updates for utilization when GPS signals are lost. As described herein, the main source of this precision is the accuracy of LDM device 20.

It is also possible to derive excellent along-track position updates when the cross-track range profile contains discontinuities. Ramps and edges in the cross-track range profile can provide very accurate along-track aiding, in many cases, the cross-track range profiles are more accurate than can be realized from a velocity sensor having an accuracy of +/−two percent.

The 100 Hz rate for LDM device 20 as described herein allows for about one inch resolution along the track which makes it possible to obtain ranges from fairly small objects even at a speed of eight feet per second. Higher rates of speed improve field performance though stronger correlation over a fixed distance (e.g., better noise rejection). At slower rates the correlation is not as strong.

The example simulations that are described herein do not take into account a heading error of IMU 54. However, Kalman Filter 62 may be configured to manage the error states associated with heading error and the overall performance of vehicle 10 would be improved from the examples described herein, especially for curving paths.

It should be noted that errors in the system perturb the reference path as well as the operational path since the path is recorded during a training pass. It would be beneficial to use a “precision” machine to create the path. Another alternative is to actually survey a few points in long outage runs and “correct” the reference path with some desktop tools.

A high precision embodiment of vehicle 10 may be fabricated if the desired path is “surveyed” with a precision machine and all the differential GPS aiding that is available and that data is utilized as an absolute latitude/longitude profile reference map. A training pass is still used to create the mower path, however, creation and correction of a measured profile would be unneeded. While described herein with respect to differential GPS, it should be understood that the embodiments are not limited to differential GPS and that other positioning systems, for example, GLONASS, Galileo, or other RF-based or light based positioning systems could be utilized for position determination.

Additional embodiments of vehicle 10 are contemplated. For example, in one alternative embodiment, a plurality of LDM devices may be incorporated, for example, each pointing in opposite orthogonal directions from the direction of travel. Such an embodiment, allows for cross-range data to be collected from either side. Alternately, a single LDM device could be used on a simple turn-table allowing it to be re-positioned left or right, either manually or automatically as needed. In still another alternative embodiment, two LDM devices are used, with one pointing 45 degrees forward and one pointing 45 degrees rearward with respect to a front of the vehicle. This configuration allows extended along-track use of cross-range targets as the vehicle approaches and leaves a location where the targets are located.

In yet another alternative embodiment, a single LDM device is rotated continuously to provide a 360 degree plane of range data. However, this type of “scanning laser” is relatively expensive as compared to the above described embodiments which utilize one or more “stationary” laser distance measuring devices.

In these embodiments, which do not utilize GNSS systems as the prime navigation device, the LDM device(s) on the vehicle are utilized to triangulate an accurate position of targets, both cross track, and along-track. In such embodiments it is possible to completely replace the GNSS component as four cardinal axis lasers or a precision scanning laser could be used during a manual navigation of the desired path to provide data for subsequent navigation of the vehicle without utilization of GNSS. The principles of training and correlation processing described above with respect to gathering of GNSS type data and LDM device data is applicable to a non-GNSS equipped version of vehicle 10 which utilizes only LDM type devices.

While the invention has been described in terms of various specific embodiments, those skilled in the art will recognize that the invention can be practiced with modification within the spirit and scope of the claims.

What is claimed is:

1. A method for navigating an autonomous vehicle along a desired path, said method comprising:
manually navigating the vehicle along the desired path for the purpose of training the vehicle, where training the vehicle comprises:
measuring an environment in the vicinity of the desired path, during the manual navigation, using at least one sensor affixed to the vehicle; and
storing the environmental measurements as a programmed path within the vehicle; and
subsequently utilizing an algorithm, the stored environmental measurements, and additional environmental measurements, to navigate the vehicle along the programmed path the algorithm utilizing a correlation algorithm, requiring multiple environmental measurements, to maintain a position of the vehicle relative to the programmed path.

2. A method according to claim 1 wherein subsequently utilizing an algorithm and additional environmental measurements comprises using a control system to provide corrections to the vehicle such that the additional environmental measurements are substantially equal to the stored environmental measurements.

3. A method according to claim 1 wherein measuring an environment in the vicinity of the desired path using at least one sensor affixed to the vehicle comprises:
utilizing a global navigation satellite system receiver on the vehicle to compare a position of the vehicle based on received global navigation satellite system signals with a position stored in the programmed path; and
determining a cross-track position of the vehicle with respect to the programmed path when the global navigation satellite system receiver is not receiving global navigation satellite system signals.

4. A method according to claim 3 wherein subsequently utilizing an algorithm and additional environmental measurements, to navigate the vehicle along the programmed path comprises adjusting a route of the vehicle to match the stored position based on at least one of the global navigation satellite system position as determined from the received signals and the cross-track position determination with respect to the programmed path.

5. A method according to claim 1 wherein measuring an environment in the vicinity of the desired path using at least one sensor affixed to the vehicle comprises:
recording global navigation satellite system data received by the global navigation satellite system receiver as the vehicle is navigated along the desired path; and
measuring distances from the vehicle to one or more objects substantially near the programmed path with a laser distance measuring device when the global navigation satellite system receiver is not receiving global navigation satellite system signals.

6. A method according to claim 5 wherein further comprising:
augmenting the measured distances with validity information; and
using an invalid number in the validity information to indicate an absence of usable cross-track range data for a given data bin.

7. A method according to claim 1 further comprising:
periodically recording a speed of the vehicle relative to ground surface during the manual navigation based on velocity data received from a speed sensor; and
operating the vehicle at the recorded speeds based on a comparison of the recorded speeds and velocity data being received from the speed sensor.

8. A method according to claim 1 wherein storing the environmental measurements as a programmed path within the vehicle comprises creating at least a portion of the programmed path based on known survey points near the desired path.

9. A method according to claim 1 further comprising utilizing data from an inertial measurement unit to maintain a level reference frame and heading angle during maneuvers of the vehicle.

10. A method according to claim 1 further comprising:
acquiring, upon initialization of the vehicle, signals from a global navigation satellite system to establish an initial position; and
performing a sequence of maneuvers to establish an initial heading for the vehicle.

11. A method according to claim 1 wherein the vehicle includes a plurality affixed thereto, wherein subsequently utilizing an algorithm, the stored environmental measurements, and additional environmental measurements, to navigate the vehicle along the programmed path comprises utilizing stored environmental measurements and additional environmental measurements from a first of said sensors to navigate the vehicle when one or both of stored environmental measurements and additional environmental measurements from a second sensor are not available.

12. A vehicle comprising:
at least one sensor affixed to said vehicle; and
a processing device configured to control movement and operation of said vehicle based upon a comparison of data received from said at least one sensor during a manual navigation, for the purpose of training said vehicle, of said vehicle along a desired path and stored within said processing device as a programmed path, and data received from said at least one sensor as said vehicle navigates the programmed path based on error data provided by an algorithm, said processing device comprising a correlation algorithm to control movement and operation of said vehicle.

13. A vehicle according to claim 12 wherein said at least one sensor comprises:
a receiver, said processing device configured to control movement and operation of said vehicle based on a comparison of signals received by said receiver and position information stored within said processing device as a programmed path; and
a distance measurement device, said processing device configured to determine a cross-track position of said vehicle with respect to the programmed path based on signals received from said distance measurement device, said processing device programmed to utilize the cross track position and corresponding information in the programmed path to control movement and operation of said vehicle when said receiver is not receiving signals.

14. A vehicle according to claim 12 wherein to provide said processing device with a programmed path, said processing device is configured to:
record data received by said receiver as the vehicle is manually navigated along a desired path;
record measured distances from the vehicle to one or more objects substantially near the desired path with said distance measuring device when said receiver is not receiving signals; and
utilize the recorded data and recorded distance measurements to generate the programmed path for said vehicle.

15. A vehicle according to claim 14 wherein to utilize the recorded data and recorded distance measurements to generate the programmed path, said processing device is programmed to:
augment the recorded distance measurements with validity information; and
use an invalid number in the validity information to indicate an absence of usable cross-track range data for a given data bin of distance measurements.

16. A vehicle according to claim 14 wherein to utilize the recorded data and recorded distance measurements to generate the programmed path, said processing device is programmed to utilize the recorded distance measurements to generate the programmed path for said vehicle for a time period before each incidence of signal loss and a time period after signals are again received after an incidence of signal loss.

17. A vehicle according to claim 14 further comprising a speed sensor, said processing device programmed to:
periodically record a speed of said vehicle relative to a ground surface during the manual navigation based on velocity data received from said speed sensor;
utilize the recorded speed data in generating the programmed path for said vehicle;
operate the vehicle at the recorded speeds based on a comparison of the recorded speeds within the programmed path and velocity data being received from said speed sensor; and
determine an along-track position of said vehicle with respect to the programmed path.

18. A vehicle according to claim 14 wherein to determine a cross-track position of said vehicle with respect to the programmed path, said processing device is programmed to:
cause said distance measuring device to measure distances from said vehicle to one or more objects substantially near the programmed path; and
compare each measured distance with a previously measured distance stored in the programmed path.

19. A vehicle according to claim 13 wherein said distance measuring device comprises a laser distance measuring device.

20. A vehicle according to claim 12 further comprising an inertial measurement unit, said processing device programmed to utilize data from said inertial measurement unit to maintain a level reference frame and heading angle when controlling movement and operation of said vehicle.

21. A vehicle according to claim 12 wherein to control movement and operation of said vehicle upon initialization, said processing device is programmed to:
establish an initial position for said vehicle based on signals acquired by a receiver; and
cause said vehicle to perform a sequence of maneuvers to establish an initial heading for said vehicle.

22. A vehicle according to claim 13 wherein said receiver comprises a global navigation satellite system receiver.

23. A vehicle according to claim 12 comprising a plurality of said sensors, said processing device configured to control movement and operation of said vehicle based upon a comparison of data received from a first said sensor during a manual navigation of said vehicle along a desired path and stored within said processing device as a programmed path, and data received from the first said sensor as said vehicle navigates the programmed path when, with respect to a second said sensor, one or both of manual navigation data and data received from the second said sensor as said vehicle navigates the programmed path are not available.
